(19) United States
(12) Patent Application Publication
(10) Pub. No.: US 2017/0091244 A1
(43) Pub. Date: Mar. 30, 2017

(54) Searching a Data Structure

(71) Applicant: Microsoft Technology Licensing, LLC, Redmond, WA (US)

(72) Inventor: Alexey Romanovskiy, Mountain View, CA (US)

(21) Appl. No.: 14/864,492

(22) Filed: Sep. 24, 2015

(51) Int. Cl. G06F 17/30

(52) U.S. Cl. CPC G06F 17/30336; G06F 17/30477

(57) ABSTRACT

A data structure is formed of at least one sequence of nodes having a plurality of elementary links, each elementary link being a directional edge from a respective node in the sequence to the next adjacent node in the sequence. Based one or more predicates, a distance along each elementary link for each of the one or more predicates is computed, and stored in the data structure in association with that elementary link. The distance along that elementary link is computed for that predicate by applying that predicate to the node to which that elementary link is directed, and is zero-valued unless that node satisfies that predicate.

### BACKGROUND

A data structure may be formed of a plurality of nodes and a plurality of edges between pairs of the nodes. Some or all of the edges may be directional, in that they have a defined direction from a first node of the pair to the second node of the pair. The edges may be such as to form one or more sequences of nodes in the data structure, whereby adjacent nodes in the sequence are joined together by edges. Additional edges may also join non-adjacent nodes in the sequence, for example in a skip list. Each of the nodes may contain a node value, and have a separate index—either of which can be used to search the data structure. An index of a node represents a defined position of that node in the data structure relative to a reference node in the data structure, for example the very first node in a list or the root node of a tree, and is typically represented as an integer value or set of integer values according to a desired definition.

An “index lookup” means a search for a node in a data structure that has a target index T, which is performed by comparing the target index T with the indices of nodes in the data structure until a matching index is found, e.g. in order to output the node value of the node having the matching index as a search result. This is an example of “positional access”. Positional access means accessing nodes based on their position in the list, rather than based on their node values.

This is in contrast to a “value lookup”, which searches node values directly by comparing the node values of nodes in the data structure with a target node value until a matching node value is found.

Unlike a value lookup, the search time for an index lookup is substantially unaffected by the structure or contents of the nodes themselves, which may for example have node values that are strings, floating points or more complex individual data structures such as vectors or matrices. Thus it is often possible to reduce search times by implementing index lookups where possible rather than value lookups.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. This section introduces mathematical notation that is applied throughout the present disclosure, including in relation to specific embodiments in the Detailed Description. The notation is provided in this section solely to aid illustration, and is not intended to limit the scope of the claimed subject matter in any way, and in particular is not intended to limit the scope to any of the described embodiments for which the same notation is used.

An electronically-stored data structure is formed of at least one sequence of nodes. The data structure may for example be a list structure formed of a single sequence, or a tree structure formed of multiple sequences that arise due to branches in the tree. The sequence has a plurality of elementary links. Each of the elementary links, denoted n.E0, is a directional edge from a respective node n in the sequence to the next adjacent node in the sequence, denoted n.E0.N for convenience. That is, each elementary link n.E0 is a directional edge between an adjacent pair of nodes in the sequence. The elementary link n.E0 may be represented as a pointer to n.E0.N that is stored in n, though this is just one possible example.

Various aspects of the present disclosure relate to optimizing the data structure for an index lookup; specifically, an index lookup that is restricted by a target predicate ƒ^{T} of a set of F predicates (F≧1). That is, the data structure is optimized so that it can be efficiently searched to quickly locate a target node n^{T} in the sequence, where n^{T} is the Tth node in the sequence, relative to a reference node n₀ (e.g. the very first node in the sequence), that satisfies the target predicate ƒ^{T}−T is the target index of the index lookup in this context. Note, in contrast to conventional index lookups, the lookup is not performed to find the Tth node in the sequence per se, but to find the Tth node in the sequence S that satisfies the target predicate ƒ^{T} whilst ignoring any intervening nodes that do not satisfy the target predicate ƒ^{T}.

In accordance with the present subject matter, based on the set of F predicates, i.e. at least the target predicate ƒ^{T}, a distance n.E0.D(ƒ) (“elementary distance”) is computed along each elementary link n.E0 of the plurality of elementary links for each predicate ƒ of the F predicate(s). That is, F elementary distance(s) per adjacent pair of nodes in the sequence are computed—one for each of the F predicates. The elementary distance n.E0.D(ƒ) is computed by applying that predicate ƒ to the node to which that link n.E0 is directed, i.e. the node n.E0.N immediately after n in the sequence; the elementary distance n.E0.D(ƒ) is zero-valued unless that node n.E0.N satisfies that predicate ƒ (and non-zero valued otherwise). The computed elementary distance n.E0.D(ƒ) is stored in the data structure in association with that link n.E0, for example in the node n or the node n.E0.N, though these are just two possible examples.

Once the distances have been computed and stored, the target node n^{T} can be located quickly in the aforementioned index lookup, starting from the reference node n₀. This is achievable because the sum of the elementary distance(s) between the reference node n₀ and the target node n^{T} will match the target index T. The index lookup will automatically skip over the zero-valued distances, corresponding to nodes that do not satisfy the target predicate ƒ^{T} and which are thus of no interest in this type of index lookup.

### BRIEF DESCRIPTION OF FIGURES

For a better understanding of the present subject matter and to show how the same may be carried into effect, reference is made by way of example only to the following figures in which:

FIG. 1A shows a skip list container;

FIG. 1B shows the skip list with a new node inserted;

FIG. 2 shows a block diagram of a user device;

FIG. 3 shows a flowchart for a method of computing distance vectors along links of a data structure;

FIG. 4 shows a flowchart of a lookup algorithm performed on a data structure;

FIGS. 5A-C illustrate a first example of how filter-dependent internode distances may be used to control a user interface;

FIGS. 6A-C illustrate a second example of how filter-dependent internode distances may be used to control a user interface;

FIG. 7 shows how a display layout may be predetermined bases on a cardinality vector stored in association with an aggregate node.

### DETAILED DESCRIPTION OF EMBODIMENTS

Before describing certain embodiments of the present subject matter, some terminology is introduced.

A “predicate” means a binary-valued function ƒ(n) i.e. that returns one of two possible output values when applied to a node n; all nodes that return a chosen one of these two output values (and only those nodes) are deemed to satisfy the filter—the choice of output value is immaterial provided a sufficient level of consistency is maintained. Purely for convenience, a convention is adopted herein whereby the two values are denoted {0,1} and a node n satisfies the predicate if and only if ƒ(n)=1.

A “filter”, when applied to an individual node n, means the same thing as predicate i.e. the binary-valued function ƒ(n); that is, to the extent they are applied to a single node, the terms “filter” and “predicate” are used interchangeably. A filter can also be applied to a set of nodes \hat{N}={n₁, n₂, . . . , n_{N}} and in this context means a function ƒ(\hat{N})={n′ε\hat{N}|ƒ(n′)=1}, i.e. that returns the subset of nodes in that set that individually satisfy the filter.

The embodiments of described below provide a container that is tailored to provide both computationally efficient index lookups and computationally efficient value-lookups (restricted by filter).

Usually, random-accessible lists are implemented with contiguous (i.e. array-like) backing storage, whereas order-maintaining structures are tree-like, and structures having one of these properties don't have the other. That is, existing structures tend to be tailored to provide computationally efficient index lookups (that is, positional access) or computationally efficient value-lookups—but not both.

A computationally efficient algorithm means is one having a relatively low algorithmic complexity given the task it is desired to perform. Algorithmic complexity means the number of processor cycles it takes for an algorithm to perform the desired task when executed on a processor. Herein, the well-known “big-O” notation is used, whereby O(g(N)) denotes the fact that the computational complexity of an algorithm grows in approximate proportion to the function g(N) as the size N of its input data set increases.

By contrast, embodiments of the present subject matter relate to a structure that satisfies both criteria. The structure is a form of skip-list. Skip-lists are known in the art, but the present disclosure provides a novel extension of inter-node distance concept for the skip list structure (that can also be applied to other types of structure—see below), which provides a number of benefits including hierarchical grouping support and cross-selection index lookup. The structure can be used to provide a fast representation of a record list, for example.

One application of this structure is the optimization of a main client application screen for performance and responsiveness.

The embodiments described in detail below relate to a data structure in the form of “container” that embodies this novel structure. A container is an object in the OOP-sense. Specifically, it is a holder object that stores a collection of other OOP objects (the container's “nodes”). As is well known in the art an OOP object is formed of a piece of object data stored in memory; the object may also have associated object code that is executable on a computer. An OOP object thus has state (the object data) and may also have behavior (provided by the associated object code).

More generally, “node” means a logical storage element, in which a node value is stored.

Herein the integer N represents the total number of nodes in a container, or more generally in a data structure. The set of all N nodes in the data structure constitutes what is referred to herein as “the universe” of the data structure.

Note the term “selection” in the context of the present disclosure has a specific, filter-dependent meaning: namely the (sub)set of all nodes in the universe that (individually) satisfy a given filter ƒ—which may be all or only some of the N nodes in the universe. Thus, each possible filter ƒ defines a respective selection of node(s) in the universe.

A container's object state comprises its constituent nodes, and may additionally comprise ordering data that embodies links between the nodes i.e. that imposes some form of ordering on the constituent nodes (though in the embodiments described below the ordering data is stored in the nodes themselves, in the form of pointers). The associated code provides one or more node functions, such as functions for adding, removing or modifying nodes.

Existing technologies rarely present instant ordering and random access in the same container; neither C++ STL, nor Java Collection Framework, nor Microsoft .NET provide a container with both properties.

Often, to implement a complicated ordered and/or filterable structure, developers resort to a relational database. However, even a relational database with auto-incremented keys does not offer fast positional (i.e. index) lookups.

Google has introduced “SparseArray” and “SortedList” containers in their Android framework and extension library respectively. However these are array-backed, so while lookups are O(log N), modifications are O(N).

By contrast, embodiments of the present subject matter provide containers that are able to satisfy the following requirements and respond to the following challenges:
strong order of items is maintained at all times, without the need for re-sort;
multiple constrained selections (i.e. restricted by different filters) may be exposed at the same time without being sorted independently, as long as the different filters have the same order criterion as one another;
a single item can be located or updated at faster-than-polynomial cast—O(log N) cost in the present solution—as the structure can accommodate ongoing updates all the time;
both value lookups and index lookups within any selection are supported: O(log N) cost in the present solution;
potentially complex internal structure does not impose extra overhead on sequential access: in the present solution, sequential iterators are O(N);
iterators over sparse selections (M<<N) are O(N) or O(M log M), whichever is lower (see below for proof);
hierarchical aggregation is supported “naturally”, without the need for an extra “re-grouping” pass: in the present solutions, aggregate items (“group headers”) co-exist with “leaf” items (see below), are stored similarly and are updated incrementally with short paths for large “batch” updates;
long sets or chains of filters don't impose significant overhead; in the present solution, extra filters come at relatively low marginal filter cost, thanks to memory caching, and can be further accelerated with SIMD instruction sets.

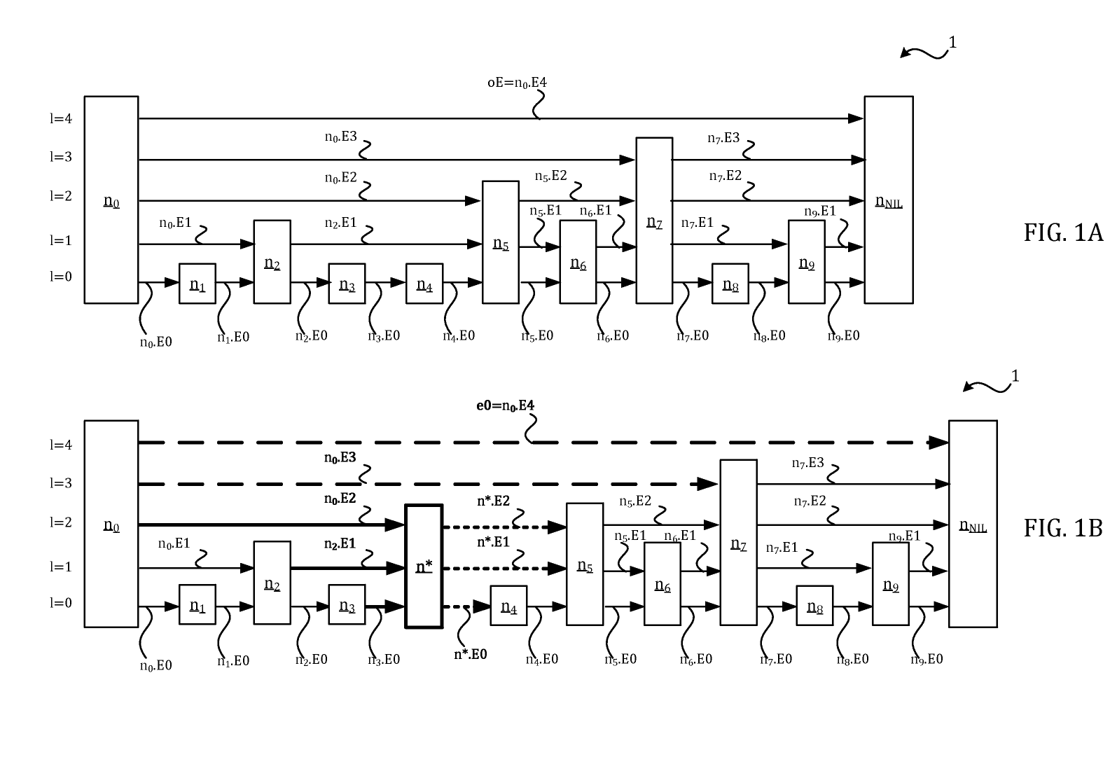

FIG. 1A shows a container in accordance with the present subject matter. The container has a link graph that is implemented as a one-way parallel-linked list of nodes, whereby the container constitutes a skip list 1.

The skip list 1 comprises a plurality of nodes \hat{N}={n₀, n₁, . . . , n₉, n_{NIL}}, which constitutes the universe of the skip list 1, and a plurality of directional edges Ê between pairs of nodes (“links”).

The following mathematical notation conventions are adopted herein for convenience.

The link directed from a node n to a later node in the sequence is denoted:

e=n.E(l);

the reason for the “l” notation will become apparent in due course. For example, a link from the node n₂ to the node n₅ is labelled n₂.E1 in FIG. 1A. Note E1 is shorthand for E(l), E2 for E(2), E3 for E(3) etc.

The node n′ to which a link e=n.E(l) is directed is denoted:

n′=e.N=(n.E(l)).N=n.E(l).N

So, for example: n₂.E1.N=n₅, because the link n₂.E1 from n₂ points to the node n₅ in FIG. 1A.

The nodes n and edges e between nodes constitute the link graph of the container 1. A change to the link graph is considered a structural change of the container 1.

The link n.E(l) from the node n is embodied as a pointer, to the later node n′, that is contained in the node n. For example, the link n₂.E1 is embodied as a pointer to the node n₅ that is contained in n₂.

A pointer to a node n′ is denoted “→n′”. The pointer can for example be a pointer to a memory location associated with n′, for example a pointer to the start of a set of memory location(s) that are reserved for n′ when n′ is instantiated in an OOP context.

In FIG. 1A the ith node in the sequence is denoted nᵢ₋₁. This is purely for convenience, and it should be noted in particular that there is no need for the value “i” or an equivalent value to be stored with the node as the sequence structure is, in this example, embodied purely by the links between the nodes i.e. by the pointers contained in the nodes themselves.

Each of the nodes n contains (i.e. stores) a respective element, denoted n.V (“node value”). The node elements are of a type that support comparison between values, either naturally or with a bespoke comparison function. The values can for example be character strings, floating points, vector, matrices or more complex data structures (on which the comparison function is defined).

FIG. 1 A shows a special HEAD node n₀ with a null element value as the list head, which is defined to be less than any other node value. A special NIL node n_{NIL} is also shown, and has a “nil” value, which is defined to be greater than any other node value. A pointer to a NIL Node N_{NIL} indicates list tail.

Note: separate special head and tail nodes n₀, n_{NIL} are shown to illustrate some of the underlying principles. However, in a practical implementation of the container 1, it is unnecessary to include two separate special nodes: as an optimization, one can be safely omitted (which depends on the implementation, as explained in further detail below).

The skip list 1 constitutes a sequence of nodes n₀, n₁, . . . , n₉, n_{NIL}. The skip list 1 is ordered by node value with respect to the comparison function—that is, for each node n but the NIL node n_{NIL}, the node immediately preceding that node n in the sequence has a lesser node value than n; for each node n but the HEAD node n₀, the node immediately after that node n in the sequence has a greater node value than n. This is not always necessary, as explained towards the end of this section.

As explained in greater detail below, the “skip” concept refers to the fact that some edges skip over nodes in the sequence, as can be clearly seen in FIG. 1A. In the example of FIG. 1A, nine nodes n₁, . . . , n₉ are shown in addition to the head node n₀ and tail node n_{NIL}—this is purely exemplary, and in practice the skip list 1 may contain many more nodes. Indeed, the present techniques have particular (though not exclusive applicability) to data structures for which N is between about 100 and 10,000.

There are at most L links any node n may contain. The integer L is called the “level count”, or equivalently the “height” of the container 1. Each link n.E(l) has a level l (“link level”) between 0 and L−1 inclusive. The lowest level l=0 is called the “elementary” level; all elementary links are directional edges between adjacent nodes in the skip list 1—such as (n₀, n₁), (n₁, n₂) etc.

Each node n has an incoming link of a given level l if, and only if, it has an outgoing link n.E(l) of the same level l. Each node n has a level n.L (“node level”), which is equal to the topmost link level that points to and from that node n—so, for example the node n₃ in FIG. 1A is node level 0, whereas the node n₅ is node level 2.

If a node n has links of link level l, it has links of all levels below 1, down to 0. All nodes contain a link at level 0. Thus each node n of node level n.L contains (n.L)+1 outgoing links from that node n to other node(s) in the skip list, and (n.L)+1 incoming links point from other node(s) in the skip list 1 to that node n.

Given any pair of nodes n, n′ in the container 1 the set of edges of level between those two nodes is denoted:

(n,n′).E(l).

So, for example, for the node pair n₂, n₆ in FIG. 1A:

(n₂,n₆).E1={n₂.E1,n₅.E1};

(n₂,n₆).E0={n₂.E0,n₃.E0,n₄.E0,n₅.E0}.

Only the HEAD node nₒ contains a link of level L−1, where L−1 is called the “orbit” level. The orbit level link is denoted oE, and points from the head node n₀ to the NIL node n_{NIL}.

The general concept of skip list is disclosed in the classic paper Pugh, “Skip Lists: A Probabilistic Alternative to Balanced Trees”, 1990 (http://epaperpress.com/sortsearch/download/skiplist.pdf). In addition to value lookups, Pugh describes lookups by position/index.

However, Pugh only introduces scalar (not vector) indices and does not touch the concepts of filters and selections, let alone hierarchical groups. In the Pugh paper, the distance between closest adjacent nodes is always 1; that is, advance by one node exposes one new element.

An existing implementation of a skip list allows non-blocking concurrent access as in Java Concurrent Collections Framework; however, this implementation does not allow positional access at all.

By contrast, in the skip list 1 of FIG. 1A, the distance between nodes (and, therefore, the index of a given element) is defined as a vector which depends on a set of filters, as explained in further detail below. This optimized the skip list 1 for a particular type of positional access, namely an index lookup restricted by a target filter in the set of filters.

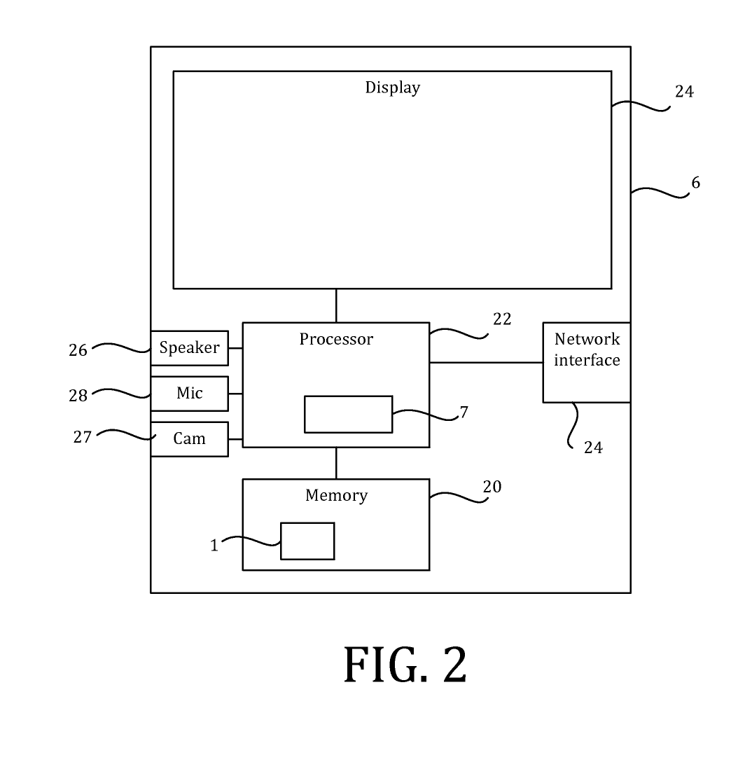

FIG. 2 is a schematic block diagram of a computer, in the form of a user device 6. The user device 6 can take a number of forms e.g. that of a desktop or laptop computer, mobile phone (e.g. smartphone), tablet computing device, wearable computing device, television (e.g. smart TV), set-top box, gaming console etc. The user device 6 comprises a processor 22 to which is connected memory 20, one or more output devices, such as a display 24 and loudspeaker(s) 26, one or more input devices, such as a camera 27 and microphone 28, and a network interface 24, such as an Ethernet, Wi-Fi or mobile network (e.g. 3G, LTE etc.) interface which enables the user device 6 to connect to a network, e.g. a packet-based network such as the Internet. The display 24 may comprise a touchscreen which can receive touch input from a user of the device 6, in which case the display 24 is also an input device of the user device 6. Any of the various components shown connected to the processor may be integrated in the user device 6, or non-integrated and connected to the processor 22 via a suitable external interface (wired e.g. Ethernet, USB, FireWire etc. or wireless e.g. Wi-Fi, Bluetooth, NFC etc.).

The skip list container 1 is embodied in the memory 22 of the user device 6. For example, a respective set of one or more memory locations in the memory 20 may be reserved for each nodeε\hat{N}, at which its node value n.V and outgoing edge pointer(s) representing its outgoing link(s) n.E(l) (l=0, . . . , n.L) are stored. This is purely exemplary; as will be apparent, there are numerous ways in which the structure and contents of the skip list 1 can be embodied in physical memory.

The processor 7 is shown to be executing code 7 for creating and managing the skip list 1. The code 7 is for creating, updating and maintaining the container 1, and implements the functionality that is described below.

The code 7 may for example comprise a communication client, for effecting communication events (e.g. calls, instant messaging sessions, screen sharing, whiteboard sessions etc.) within a communication system via the network. In this case, the skip list 1 may represent an address book of a user of the device 6, with nodes representing individual contests (leaf nodes) of groups of contacts (aggregate nodes). The client may for example be a stand-alone application that is executed on a processor of the relevant user device, or a plugin to another application executed on the processor such as a Web browser.

The client has a user interface for receiving information from and outputting information to a user of the user device 6.

The user interface may comprise, for example, a Graphical User Interface (GUI) which outputs information via the display 24 and/or a Natural User Interface (NUI) which enables the user to interact with a device in a “natural” manner, free from artificial constraints imposed by certain input devices such as mice, keyboards, remote controls, and the like. Examples of NUI methods include those utilizing touch sensitive displays, voice and speech recognition, intention and goal understanding, motion gesture detection using depth cameras (such as stereoscopic or time-of-flight camera systems, infrared camera systems, RGB camera systems and combinations of these), motion gesture detection using accelerometers/gyroscopes, facial recognition, 3D displays, head, eye, and gaze tracking, immersive augmented reality and virtual reality systems etc.

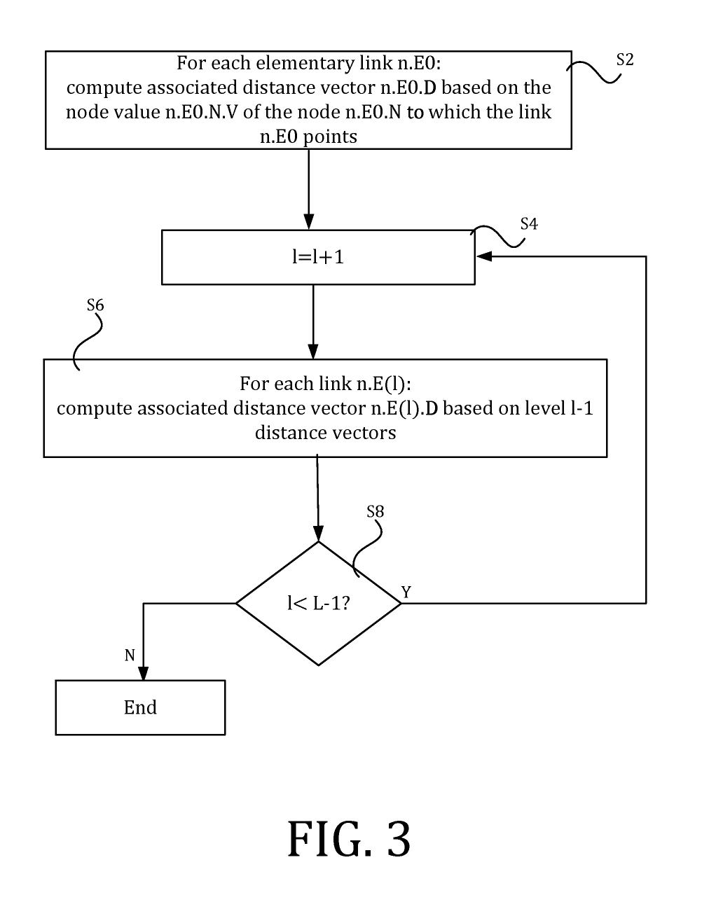

FIG. 3 shows a flowchart for a method of computing distance vectors along each of the links of the skip list 1. The method is a computer-implemented method, implemented by the code 7 when executed on the processor 22.

A distance vector e.D, having F≧1 components, is associated with each link e. The distance vector e.D represents a vector distance along that link e.

The integer F represents the total number of filters in a set of filters F={ƒ0, ƒ1, ƒ2, . . . }, on which the distance vectors are defined. That is, F is the number of filters applied or applicable to the universe N to form F distinct selections.

For each distance vector e.D, each component is defined in dependence on a different one of the filters (i.e. on a single one of the filters); the component of a distance vector e.D that corresponds to (i.e. is defined based on) a particular one of the filters ƒε\hat{F} is denoted e.D(ƒ).

At step S2, for every link e of level 0, component e.D(ƒ) of that link's associated distance vector is computed based on the node e. N to which that link e points, and is:
1 if the element e.N.V held by the node e.N satisfies filter ƒ, and
0 if the element e.N.V does not satisfy the filter ƒ.
   (“rule 0”)

Level 0 distance is called “elementary distance”, or element “projection” into the filter space.

For every link n.E of level l=1, . . . , L−1, the associated distance n.E(l). D of the link n.E(l) is computed as a vector sum of the distances of level l−1 links connecting its outgoing node n and incoming node n.E(l). N. That is according to “rule 1”:

$$n . E ( l ) . D := {\sum }_{{e}^{′} ∈ \overline{E} ( n , l - 1 )} {e}^{′} . D$$

where Ê(n,l−1)=(n,(n.E(l).N)).E(l−1). That is, Ê(n,l−1) is the set of all edges of level l−1 from the node n to the node n.E(l). N to which the link n.E(l) (i.e. one link level above) points. So for example:

n₂.E1.D=n₂.E0.D+n₃.E0.D+n₄.E0.D

and

n₀.E2.D=n₀.E1.D+n₂.E1.D

At step S4, l is increase by one and, for each link n.E(l) of level l, the associated distance vector n.E(l). D is computed by applying rule 1 to the links one level below i.e. l−1. In this example, the computed distance vector n.E(l). D is stored in the node n (i.e. from which the link n.E(l) points) in association with the pointer→n.E(l) representing the edge n.E(l). Alternatively, the computed distance vector can be stored in the node n.E(l). N to which the link n.E(l) points. The two approaches are equally viable.

As mentioned above, in a practical implementation, one of the special head or special tail node n₀, n_{NIL} can be safely omitted.

In the case that distances are stored in the nodes from which they point, the head node n₀ stores at least one distance i.e. the elementary distance (l=0) that accommodates the projection of the first “actual” (i.e. non-special) value stored in the container. By contrast, nothing needs to be stored in the terminal node n_{NIL} at all, so no there is no need to maintain the terminal node object at all: pointers to it can safely be NIL themselves.

In the case that distances of edges are stored in the nodes they point to (rather than in the nodes they point from), the special initial node n₀ can be omitted i.e. the first node in the sequence is simply the node containing the first (i.e. lowest) actual value, and the terminal node contain NIL as payload as well as the distance vectors associated with any links pointing to it.

If l<L−1 (S8) the method returns to step S4, so that l is increased by one again (to a maximum of L−1) and step S6 repeated for the new level. Once step S6 has been performed for the single orbit level (L−1) link oE, all links in the skip graph 1 will have been assigned distance vectors and the method ends.

By axiom of complete induction, the length (i.e. the vector link distance sum) of any one-way path between two nodes is the same irrespective of the waypoints chosen.

Each node n has an index vector n.I, which is defined as a total distance vector from the head node n₀ to that node along links of that level; that is as:

$$n . I := {\sum }_{{e}^{′} ∈ E ( {n}_{0} , n ) . E 0} {e}^{′} . D ;$$

n.I(ƒ) is used to represent the component of n.I for the filter ƒ. Note that the index n.I does not have to be computed and pre-stored in or with the skip list 1—it can be computed as and when it is needed for a given node in a loop process (see below). Note also that, as is evident form rule 1 above, the index n.I can be computed using higher level links—for example, the index n₉.I of the node n₉ in FIG. 1A can be computed by summing the distance vector n₀.E3. D (associated with the level 3 link from the head node n₀ to the node n₇) and the distance vector n₇.E1. D (associated with the level l link from the node n₇ to the node n₉). This is more computationally efficient that computing the index n.I using lower level distances; computational efficiency is generally maximized by computing the index n.I using the highest level links possible, as this minimizes the number of distance vectors that have to be summed.

As long as the distance S:=oE. D associated with the single orbit level link oE of L−1 from the HEAD node n₀ to the NIL node n_{NIL} accommodates all elements' projections, each component S(ƒ) of S represents a size (the cardinality) of the respective selection of the filter ƒ i.e. the cardinality of the subset of nodes in the universe \hat{N} that satisfy the filter ƒ.

To include a new node n* in the skip list 1 (to accommodate a new element), the skip list 1 is updated according to the following process. The new node n* is assigned a node level n*.L that is selected at random according to the following randomized procedure (as described in the Pugh paper referenced above):
1. the node level n*.L is initialized as n*.L=0;
2. if the node level n*.L is less than or equal to the current topmost level (besides the HEAD node level)—i.e. n*.L≦L−2—the level n*.L is incremented by 1 at 1/R probability; otherwise (i.e. if the node level n*.L has reached L−2) stop at the current node level;
3. if the node level n*.L was increased in the most recent iteration of step 2, repeat step 2; otherwise stop at the current node level.
   Thus, the probability of the new node being assigned a given node level decreases for higher node levels. The value R is called “ratio” or “denominator” of the container.

More advanced loop conditions can be applied at step “3”, for example to “manually prettify” the distribution, such as (but not limited to) only allow a 1-increment to the topmost level of payload-carrying nodes—e.g. if the container has 10 levels, and existing nodes have levels of 0, 3, 1, 0, 2, 0, 1, 0—only allow a node being added to have a level of 4 or lower (see e.g. “A Skip List Codebook”, Pugh, 1990). These and other implementation details still maintain the overall staged or progressive or hierarchical elevation pattern, whether probabilistic or deterministic or pseudo-random, irrespective to the exact flow of the level computation algorithm.

In some cases, the level of the node is stored within the node itself to optimize iteration. It is not used for single-item lookups. If optimized sequential iteration is not needed, the level need not be stored. Benchmarks show that a reasonable value of the ratio is 3 or 4; 4 is advised for division efficiency. L is then adjusted to accommodate, at most, N=R̂(L−1) elements. (The container capacity is not limited to N, but in case of significant overload lookup cost will degrade to O(N)).

The new node n* is then inserted at a suitable position in the skip list 1, whereby the sequence remains ordered by node value i.e. the node vale of the node at the position immediately before that suitable position is less than the node value n*.V contained in the new node n*, and the node value of the node at the position immediately after that suitable position is greater than n*.V.

Outgoing links from n* are created as follows: n*.L+1 links outgoing links of different link levels l=0, . . . , n*.L are created from the new node n*. For each of the link levels=0, . . . , n*.L, the new link n*.E(l) points to the next node n^{NEXT} in the sequence having a node level n^{NEXT}. L equal or greater than 1, skipping over any intervening node(s) of lower levels where applicable. These outgoing links are embodied as n*.L+1 pointers contained in n*.

Incoming links to n* are created as follows: for each of the link levels l=0, . . . , n*.L, the first node n^{PREV} in the sequence having a node level n^{PREV}.L≧l is identified. The outgoing link from n^{PREV} is modified so as to point to n*, by modifying the corresponding pointer in the earlier node n^{PREV} (before the modification, this edge will have pointed to another node that is now after n* in the sequence).

An example is illustrated in FIG. 1B, which shows a new node n* inserted between nodes n₃ and n₄ in the skip list 1. The new node has a node level n*.L=2 assigned according to the above-described randomized procedure. Thus, three outgoing edges n*.E0, n*.E1, n*.E2 are created from n* to nodes n₄ and n₅ as shown; conversely, three incoming edges n₃.E0, n₂.E1, n₀.E2 are modified so as to point to the new node n* by modifying the corresponding pointers in nodes n₃, n₂, n₀ respectively.

When a new node is inserted, this has an effect on the following distance vectors:
for node level l=0:
   a new distance vector n*.E0.D is associated with the new elementary outgoing link n*.E0 from n*, based on the node value n*.E0.N.V of the node n*.E0.N to which the elementary link n*.E0 points according to rule 0 above;
   the distance vector associated with the modified incoming elementary link that now points to n* now depends n*, i.e. it is now computed based on the node value n*.V of the new node n* itself according to rule 0;
for each of the node level(s) l=1, . . . , n*.L (if any: n*.L can be 0): as per rule 1 (see above):
   the distance vector n*.E(l). D associated with the new outgoing link from n* of level l is computes as per rule 1 above, and thus depends on the distance vector associated with the new outgoing link of the level one below i.e. n*.E(l−1).D;
   similarly, any change in the distance vector associated with the incoming elementary distance to n* of level l−1 causes a corresponding change in the incoming link of level l pointing to n* of the level l according to rule 1;
for each of the node levels l=n*.L+1, . . . , L−1, i.e. the level(s) above the node level n*.L of the new node n*:
   there exists a link of that level l that goes over the new node n* i.e. one link from a node in the sequence before the new node n* to a node after n* in the sequence (both having node levels of l or greater)—as per rule 1, the distance associated with that link now depends on both the new distance vector associated with the new outgoing link of level n*.L from n* and the modified incoming distance vector of level n*.L to n*. For L−1, this is the orbit level link oE.

This, in turn, changes the index vector n.I of all nodes n after the new node n* in the skip list—though not necessarily every component as n*.I(ƒ) can be zero for one or more of the filters ƒ.

To aid illustration, in FIG. 1B, the new links that are added to the sequence to accommodate the new node n* are shown as dotted arrows of increased thickness—these are the links for which new distance vector are computed. The existing links which need to be modified to point to n* are shown as solid arrows of increased thickness—their associated distance vectors also need to be modified depending on the node value of n*.V. The links going over n*, which are themselves unchanged but whose associated distance vectors are changed by the insertion of n*, are shown as dashed arrows of increased thickness. For the remaining links, shown as arrows of the same thickness and style as FIG. 1A, neither the links nor the associated distances are changed by the insertion of the new node n*—for a large skip list having e.g. several hundred nodes, this will be the majority of links.

As will be apparent, removing a node from the sequence essentially involves performing the reverse of these operations (with similar consequences for the distance vectors associated with select nodes all the way up to the orbit level L−1).

Moving a node in the sequence—e.g. to maintain the ordering by node value when the node's value change—is performed by removing the node from its current position and inserting it at a new position.

Further, as will be apparent, changing the value of n* does not change the structure of the links but it can change the distances associated with the same set of links. That is, suppose n* is not a new node being inserted in the sequence, but an existing node whose value is being modified—assuming the node is maintained at the same position in the sequence, the distances that can be effected by this are those associated with precisely the same set of links that are shown as arrows of increased thickness in FIG. 1B.

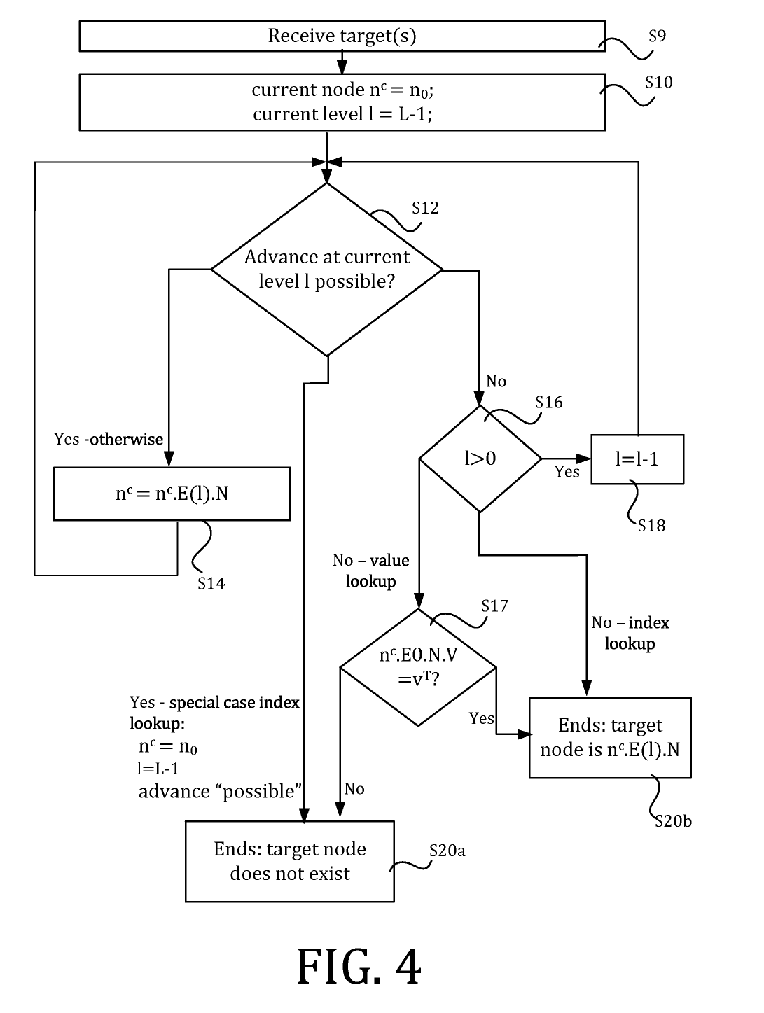

FIG. 4 shows a flowchart for a filter-dependent lookup template algorithm, implemented by the code 7 when executed on the processor 22. The algorithm is performed to locate a target node n^{T}, either by performing:
a value lookup, i.e. in this case the target node n^{T} is the one having a node value that matches a target value v^{T}; or
an index lookup, i.e. in this case the target node n^{T} is the one having a target index T=I_{ƒ}_{^{T}} for a target filter ƒ^{T}.
   Depending on the type of lookup, at step S9 a search target(s) for the search is received: either the target value v^{T}, or the target index T and an indication of the target filter ƒ^{T}.

The search target(s) of step S9 may for example be received via the user interface, and or from another code module being executed by the processor 22 (e.g. another code module of the client 7, or of a separate application or operating system).

The lookup algorithm commences with the HEAD node n₀ as a current node n^{c} (i.e. n^{c}=n₀) and a current level l as the orbit level (i.e. l=L−1)search ends at, either unsuccessfully i.e. by determining that the target node does not exist (S20a), or successfully i.e. by identifying the target node (S20b)—which is always the node n^{c}.E0.N immediately after the current node n^{c} if the target node exists.

In the case of an index lookup, the search is guaranteed to end successfully in this scenario as the node n^{c}.E0.N immediately after the current node n^{c} is guaranteed to be the target node n^{T} (if an index lookup makes it as far as step S16 then the target node must exist, by virtue of the effective bound check of step S12). Thus, for an index lookup, by determining that a step down is not possible at step S16, the target node n^{T} is automatically identified as the next node n^{c}.E0.N.

In the case of a value lookup, if the target node exists (which is not guaranteed as there may be no node in the sequence having the target value V^{T}), then it must be the next node n^{c}.E0.N, as the sequence is ordered by value. Thus, for a value lookup, at step S17 the value n^{c}.E0.N.V of the next node n^{c}.E0.N is compared with the target value V^{T} to determine whether they match—thereby identifying n^{c}.E0.N as the target node n^{T} if the values match (S20b), or determining that the target node does not exist if they don't (S20a).

The target node's accumulated distance n^{T}.I(ƒ^{T}) from the HEAD node n₀ can be reported i.e. supplied as an output of the algorithm, for example for use in cross-index lookup and for reverse index lookup.

A reverse index lookup is a lookup by value reporting position (as a complete vector or as its specific component).

A cross-index lookup is a lookup by a selection-specific index to find out the complete position vector (or at least a different component of it i.e. for a different filter).

For example, assume the skip list 1 were a list of students in the class (each represented by a node), sorted alphabetically, with the following predicates applied: “is a girl”, “is a boy” and “is an English learner”. Assuming Catherine is an English learner, a reverse index lookup for Catherine will indicate she is the g-th girl and the e-th English learner. A subsequent cross-index lookup for the g-th girl will indicate that she is the e-th English learner, (or vice versa, that the e-th English learner is the g-th girl).

Alternatively or in addition, the value n^{T}.V it stores can be reported, e.g. for direct lookup by index.

Once the target node n^{T} has been located, the node value n^{T}.V that it stores can also be modified. This, in turn, may necessitate moving the node n^{T} in the sequence to preserve the ordering.

The index lookup of the algorithm FIG. 4 is derived from the Pugh paper referenced above.

However, it is only the present application that recognizes that the algorithm of index lookup stays valid when the distance between adjacent nodes is 0 (that is, advance by one node exposes no new elements) Importantly, this means that the same link graph can be used to represent an arbitrary number of selections within the same universe.

The index lookup described with reference to FIG. 4 is a form of positional access. Positional access may for example be used to satisfy requirements of view widgets, such as Android ListView/RecyclerView, or tables and spreadsheets in office web applications. Positional update notifications may be used to update such components in a carbon footprint efficient way.

The computational complexity of an index lookup is O(log N)—reduced from O(N) through the use of levels above zero.

As noted above, sequential iterators are O(N). That is, Full traversals are upper-bounded by O(N), corresponding to a one-by-one traversal at level 0.

Iterators over sparse selections (M<<N) are O(N) or O(M log M), whichever is lower. The upper bound holds even if the distance vector degenerates to a distance scalar (e.g. there is only one predicate). The proof is as follows:
1. Traversal over the entire container by following only zero-level (elementary) links takes O(N) time, one step per link.
2. Traversal over a sparse selection (M<<N) cannot be less efficient than index search of every individual element, preserving no state across searches. Index search is O(log N) because each selection element can be retrieved by random index access, hence O(M log N) total.

The universe can be maintained as a dedicated selection—i.e. one of the filters in \hat{F} (“universal filter”) may be universally satisfied i.e. satisfied by each and every node in N, which is convenient for clients of the structure (though not essential)—purely by convention, the universal filter is denoted ƒ0 herein.

If a modification is to be applied to the node (value change, node insertion or node removal), it is required to track all predecessor nodes of the current node at all levels. Therefore, the iteration algorithm of FIG. 4 tracks these links in a section object SO, which is a node pointer array of length L. Here, “predecessor node” of a current node n^{c} at a given level l means the first node n^{PREV} before the current node n^{c} that has a node level n^{PREV}.L≧l.

So, for example, for the node n* in FIG. 1B, the predecessor nodes are:
l=4: n₀ (n₀ is the always the predecessor node at the orbit level L−1)
l=3:n₀
l=2:n₀
l=1:n₂
l=0:n₃
   As will be apparent, this set of nodes is precisely the set of nodes for which the associated distance vectors can change when the value n*.V of n* changes, as described above.

Thus, when n* is the current node n^{c}, the section object is an array of pointers:

SO=(→n₀,→n₀,→n₀,→n₂,→n₃)

Should the algorithm then progress to, say, the node n₅, the section object is updated as:

SO=(→n₀,→n₀,→n*,→n*,→n₄,)

Every update to the container 1 generates notifications of the following formats:
element being updated, or a special value (null) to indicate that the entire universe is being updated;
position of the update, of D distance type, or a zero vector for an entire-container update. The D distance type is an integer vector of as many dimensions as there are filters/predicates defined;
“impact” of the update, of D distance type or saturated to a Boolean[F] vector, indicating which selections have been affected (in any way, even non-structurally) by the update.
element count delta, of D distance type, one component per filter/selection. To avoid eager evaluation, the distance component may be delivered along with a scalar multiplier (e.g., when an element of projection D0 is moved from one position to another, the same D0 vector is reported with a −1 pre-multiplier on removal and a 1 pre-multiplier on addition).

### Computation of Distance Vectors:

Filters may be pre-assigned (“offline”) and/or post-assigned (“on-the-fly”). That is, the components of the distance vectors may be computed online or on-the fly, or some may be pre-computed offline and the rest on-the-fly. Each time a filter is added or removed from \hat{F}, this increases or reduces the dimension of the distance vectors by one respectively.

There is an O(N log N) cost of re-computation of all distances each time a filter is added while preserving the link graph. This allows for both pre-defined and dynamic filtering.

Filters may be chained to “trim off” most candidates by a computation-efficient (or less often changed) precondition and then apply more costly, or more often changed, post-condition.

For example, where the node values are character strings, distance components may be pre-computed for a set of filters {ƒₐ|aεA} where A is the set of all letters in the alphabet i.e. A={“a”,“b”,“c”,“d” . . . }; a string S1 satisfies filter ƒₐ if an only if the first character in the string S1 equals a; so for example:
the string “cat” satisfies ƒ_{“c”} but not ƒ_{“a”}, ƒ_{“b”} ƒ_{“d”} etc.
   Thus, when a user input inputs a first character of a search term (e.g. “c”), the pre-computed filters can be used to find all strings in the skip list 1 starting with that character using pre-computed distance components e.D(ƒ_{“c”}).

Then, as the user adds characters to the search term—e.g. “a” so that it becomes “ca”, then “t” so that it becomes “cat”—the filters ƒ_{“ca”} and then ƒ_{“cat”} can be added and the additional distance components computed on the fly. Note, distance vectors are computed rather than used at this point in time. This is an optimized algorithm to produce an elementary distance vector in a more efficient way than evaluation of each predicate over each value each time independently.

Because of the dependency between ƒ_{“c”} and ƒ_{“ca”}, the distance component e.D (ƒ_{“ca”}) can be computed cheaply when the distance component e.D(ƒ_{“c”}) is known—for all edges e for which e.D(ƒ_{“n”})=0, e.D(ƒ_{“ca”})=0 also because any node which does not satisfy ƒ_{“c”} cannot satisfy ƒ_{“ca”} (as every string beginning “ca” begins with “c”). Thus in computing e.D(ƒ_{“ca”}), ƒ_{“ca”} only need to be applied to nodes which do satisfy ƒ_{“c”} i.e. only those nodes containing strings that do start with “c”—a typical situation is that most of these won't satisfy ƒ_{“ca”} but a few will (because most words that start with “c” do not have “a” as their second letter). This is the “trimming off” referred to above, whereby the distance components already computed for ƒ_{“c”} are used to greatly reduce the number of computations that need to be performed in computing the distance components for ƒ_{ca}.

Similarly, in computing e.D(ƒ_{“cat”}), ƒ_{“cat”} only need to be applied to nodes which do satisfy ƒ_{“ca”}, which is even cheaper. That is, ƒ_{“ca”} is used to trim off ƒ_{“cat”} in the same way.

### Grouping of Nodes:

Grouping can be implemented with the following extensions to the model.

The notions of “leaf” and “aggregate” items are introduced:
A “leaf” item is a “real” item, representing a real entity, i.e. independent business entity, according to a desired data model.
An “aggregate” item indicates the beginning of a contiguous group (range) of “leaf” items. An aggregate item does not represent an independent business entity, and could for example represent a header, caption, footer etc.

For example, the skip list may be used to represent a user's address book in a communication system. Each leaf node contains a leaf item as its node value representing a contact of the user. Each aggregate node represents a (sub)group of the user's contacts, and contains an aggregate item, which constitutes a header representing the (sub)group.

Note, placement of an aggregate element (“header”, “caption” etc.) in the beginning of the range it represents is solely a matter of desired effect. An aggregate node could, for example, be placed at the end of its range (i.e. after the last node in the range), or even in between two nodes in its range.

If desired, a “leaf” element can be part of two or more groups, for example respectively “header” and “footer” respectively, the former placed before the leaf range and the latter after—this may be used to achieve complex visual element range decoration with minimal processing overhead.

An aggregate node may even be placed in the middle of the range (e.g. a tutor or chaperone may be placed in the middle of a group of students by alphabetical name ordering).

An effect of aggregated groups implemented the described way is to provide the ability to query the number of elements in a specific group by a O(1) (amortized constant time) lookup. With aggregate-preceding-leaves or aggregate-following-leaves rules, this may be used for more efficient visual item placement on the list display media (e.g. if items are spread into columns of fixed height or rows of fixed width, it is possible to determine how many empty cells to leave at the end at O(1) time). Group nodes do not rely on the randomized partitioned container implementation (skip list, cartesian tree, etc.). Group cardinality can for example be stored in an unordered map (e.g. hashmap) indexed by group key. A grouping implementation may be a subclass of a (still consistent and ready-for-use) group-unaware one.

A dedicated filter—denoted ƒ1 herein purely for convenience—is included in \hat{F} to distinguish an aggregate item from a leaf item. That is, ƒ1 is defined such that for each node n:
n.V satisfies ƒ1 if n.V is a leaf item;
n.V does not satisfy ƒ1 if n.V is an aggregate item.
   Alternatively, this definition may be reversed i.e. so that ƒ1 is satisfied by aggregate nodes (and only aggregate nodes).

In addition, the following functions are provided by the client 7:
An alphabet of group “keys”, such as a character alphabet for alphabetical index, or an ordered scale of named value ranges, such as “small”, “medium” and “large”, or, for time frames, “today”, “yesterday”, “last week”, etc.
A 1-1 mapping between a group key (that identifies a group i.e. a group identifier) and an aggregate item (that represents a group for the user);
A 1-K mapping between an arbitrary container element and K keys of groups it belongs to. (In simple “semi-flat” implementations, K may be at most 1). Groups may be contiguous, and in this case are also called “ranges”).
A 1-1 mapping between a group key and a group cardinality vector. This may for example be implemented efficiently as a hash table, whereby a hash of the group key is associated in the memory 20 with the cardinality vector of the group stored in the memory 20.

Each group is originally created with a zero group cardinality vector.

Any per-element positional update adds its effective delta to the cardinality vectors of all groups the affected element belongs to. Therefore it is important to deliver updates both before and after element modification if grouping is or may be affected. The cardinality vector of a group g is denoted g.C.

This, suppose there are four filters: ƒ0 (the universal filter), ƒ1 (the group-only filter), ƒ2 and ƒ3. If a leaf node is added to a group which satisfies the filter 13 but not the filter 12, the stored cardinality vector is modified as g.C=g.C+(1,0,0,1) in response. Here, g.C(ƒ0)=1 as every node satisfies ƒ0; g.C(ƒ1)=0 as the new node is a leaf node; g.C(ƒ2)=0 and g.C(ƒ3)=1 due to the individual properties of the node. If the new node being added to the group is itself a group node, but otherwise the same, g.C=g.C+(1,1,0,1); if it were a group node that satisfied both ƒ2 and ƒ3, g.C+(1,1,1,1) etc. Similarly, the original leaf were to be removed, the stored cardinality vector is modified as g.C=g.C−(1,0,0,1) in response.

Note that, whilst is some contexts it is convenient for groups to be contiguous, this is not essential. For example, group cardinality vectors can still be stored in association with aggregate nodes defining non-contiguous groups.

Projection of an aggregate element is, by default, redefined in the following way: an aggregate element passes (i.e. satisfies) filter ƒ if, and only if, its cardinality component ƒ is nonzero. In other words, a group/section/range shows up in selection ƒ if, and only if, the selection contains “real” elements from the group/section/range, to make sure that no group expands to an empty sub-list of elements.

That is, for at least one filter of the F filters, each aggregate node satisfies that filter if and only if at least on leaf node in the group satisfied that filter. This is true of each filter by default i.e. unless the behavior is redefined for a specific filter/predicate to further refine knowingly aggregate nodes (example: if students are ordered by height and further grouped by T-shirt size, a subsequent filter may determine if a specific T-shirt size is available for sale on campus).

Bulk update optimizations are possible, accumulating updates to group cardinality vectors and postponing actual insertion/removal of aggregate items.

### Hierarchical Groupings:

Hierarchical groupings may be used for instant ‘prettification’ of a user representation of a changing data set—nothing, by design, “sticks in caches”, and nothing in the design encourages further caching.

The grouping is hierarchical in that group nodes can represent groups which themselves contain one or more group nodes (e.g. leaf nodes, groups, groups of groups etc.) to any extent.

With hierarchical grouping, cross-index lookups may be used to deliver grouping/sectioning within data to UI widgets without computing or transferring it in full (see Android SectionIndexer contract).

### Link Graph Conservative Updates:

Incoming updates are link graph conservative, and allow further hints from the mutator, i.e. if it is known AOT that modification E0 does not affect the sorting criterion, it can be applied in-place without even considering element reordering; however, if modification E1 is declared “potentially affecting ordering” but in fact preserves order, the link graph will not be mutated either.

### Cross-Index Lookups:

Cross-index lookups may be used to correlate events between small human-observable selections from a large universe. For example, in the context music/video editing and/or to correlate hardware sensor samples. A “bookmark” set on one of the data sets can be used to navigate over another, provided they represent selections from the same universe.

With hierarchical grouping, cross-index lookups may be used to deliver grouping and/or sectioning within data to UI widgets without computing or transferring it in full (see Android SectionIndexer contract).

### Parallel Re-Computation:

Despite the fact that the container is thread unsafe, costly filtering re-computation may be offloaded to parallel threads so that independent filters are re-computed independently in parallel.

The concept of program threads is well known in the field of parallel computing. Each thread of a program has its own program counter, stack and registers, and parallelism is generally implemented by time slicing (whereby each thread is allocated a fraction of the processors processing resources per unit of time).

Only mutual exclusion between filter re-computation and structural modification is required; for example, a queue of pending updates can be used. The number of pending updates in the queue may be used to decide what kind of notifications (fine position-wise or full state transfer) it is most efficient to send to an observer, considering the way they in turn aggregate incoming updates.

### Example Uses:

To aid illustration, some exemplary uses of the described tetchiness will now be described. In particular, examples of how the described techniques can be used to control a user interface in a computationally efficient manner.

### Contact List Navigation:

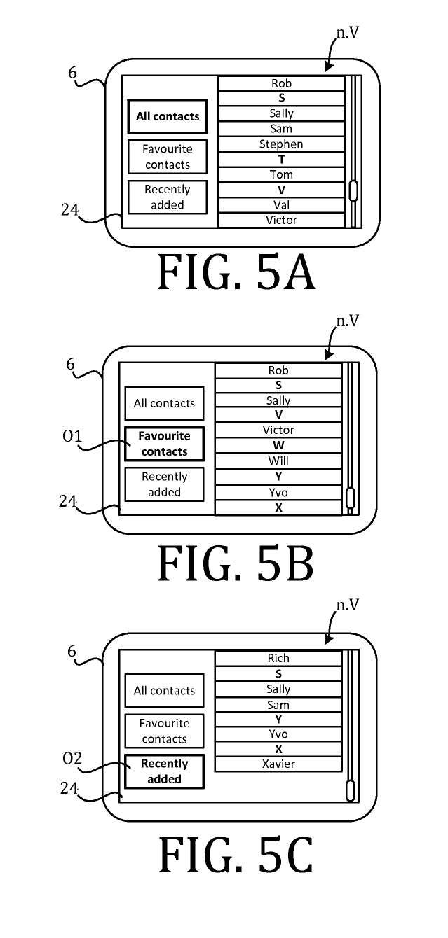

FIGS. 5A-C illustrate a first example of how the above-described techniques can be used to control the user interface of the client 7. In this example, the container 1 represents the user's contact list, whereby node values n.V are displayed in a list format on the display 24. Each of the views of FIGS. 5A-C is defined by a respective filter, in that only nodes which satisfy that filter are displayed in that view by the client 7.

Each leaf node corresponds to a contact of the user, and contains a string representing that contact's name as its node value. Each aggregate node corresponds to a letter of the alphabet, and represents the group of contacts whose names begin with that letter.

FIG. 5A shows the display 24, on which is displayed a “full” contact list view, defined by a filter “f_full” which is satisfied by all leaf nodes and all non-empty group nodes. A part of the contact list beginning with the leaf node “Rob” and ending with the leaf node “Victor” is displayed. It can be seen that the aggregate nodes “S” and “T” are not empty, due to the leaf nodes “Sally”, “Sam”, “Stephen” (starting with “S”) and “Tom” (starting with “T”) respectively. There are no leaf nodes having values that beginning with “U”; thus the aggregate node “U” is not displayed as it is empty, though it may still be present in the underlying container 1, and the list skips to the aggregate node “V”, followed by the contacts “Val” and “Victor” in that group.

By selecting a selectable option O1 displayed on the display 24, causing the client 7 to generate a first mode switch instruction, the user can switch to a “favourite” contact list view. This view is defined by a filter “f_fav” that is satisfied by leaf nodes representing the user's favourite contacts, and aggregate nodes corresponding to groups that contain at least one favourite contact (i.e. according to the “default” definition, above). For example, f_fav may be defined such that it is satisfied by nodes representing contacts with whom the user has communicated more than a predetermined number of times in a certain interval of time. In this example, the first-displayed contact in the view of FIG. 5A (i.e. “Rob”) is also a favourite contact, and is thus remains visible.

In order to provide a coherent switch and maximise consistency between the view of FIG. 5A and the new view of FIG. 5B, a cross-index lookup may be used as follows. Assuming it is known that the index I(f_full) for the full filter f_full of the “Rob” node is P, i the index I(f_fav) for the favourite filter “f_fav” can be determined with a computational efficient cross-index lookup: starting at the initial node no, run through the list accumulating, in parallel, node indexes for both the favourite filter ƒ fav and the full filter f_full, stopping when I(f_full) reaches P i.e. on the “Rob” node, thereby computing the index I(f_fav) of that node, denoted Q. This involves only one run through the data structure, and the two indexes can thus be computed in parallel in O(log N) time. Note that more than two indexes can be computed in parallel (e.g. every index for every filter) in this manner, still in O(log N) time, by accumulating each separately.

When the user switches to the view of FIG. 5B, the first node to be displayed in the list is the first node in the container having the index (I_fav)=Q—also the “Rob” node in this example. Thus, even though the lists have changed, a common starting point is maintained. This node can be located in the container 1 by an index-lookup for the target index Q, in accordance with the algorithm of FIG. 3.

As will be apparent, navigating the container 1 by the indexes P, Q is generally more computationally efficient than a corresponding value lookup on the value “Rob”.

Even in the case that the index I(f_full) is not known for the “Rob” node, the index I(f_fav) can still be determined by a reverse-index lookup on the value “Rob”, i.e. by working through the container 1 accumulating I(f_fav) until the node value “Rob” is found. This still represents a saving in terms of computational complexity, as the subsequent index lookup for f_fav with target Q is more efficient than a second value lookup.

Turning to FIG. 5C, here is illustrated a “recently added” contact view, defined by a filter “f_recent”, and generated by selecting a second selectable option O2 displayed on the display 24, causing the client 7 to generate a second mode switch signal. For example, f_recent may be satisfied by only those leaf nodes representing contacts who have been added to the user's contact list within a recent interval of time and aggregate nodes corresponding to groups containing at least one such leaf node (i.e. according to the “default” definition, above).

In this example, the underlying principle by which the list switch is effected is the same, based on cross-index lookup where possible or reverse-index lookup otherwise. However, in this example the contact “Rob” is not a recently added contact, so the “Rob” node does not satisfy the recent filter ƒ recent. As will be apparent in view of the description above, the index I(f_recent) for the Rob node, denoted Q′, will thus equal that of an earlier node in the sequence. As a result, by applying the same techniques as used in generating the view of FIG. 5B, i.e. an-index look to locate and display the first node in the container 1 having the index I(f_recent)=Q′, the node that will be located will in fact be the first node before “Rob” to have the index I(f_recent)=Q′—“Rich” in this example; “Rob” is not displayed in FIG. 5C, as it does not satisfy the filter ƒ recent, but by applying the same technique, consistency is still maintained by displaying one of the closest-possible nodes to “Rob in its place.

Note also that, when the “default” rule for aggregate nodes is followed (i.e. the aggregate node satisfied a given filter if an only if at least one node in the group it defines satisfies that filter), this ensures that group nodes are only displayed when they are useful—e.g., should a contact beginning with “U” be added to the container, the group node for “U” sill automatically be displayed din the view of FIG. 5A; similarly, should the contact “Tom” be removed, the group node for “T” will automatically no longer be displayed in the view of FIG. 5A.

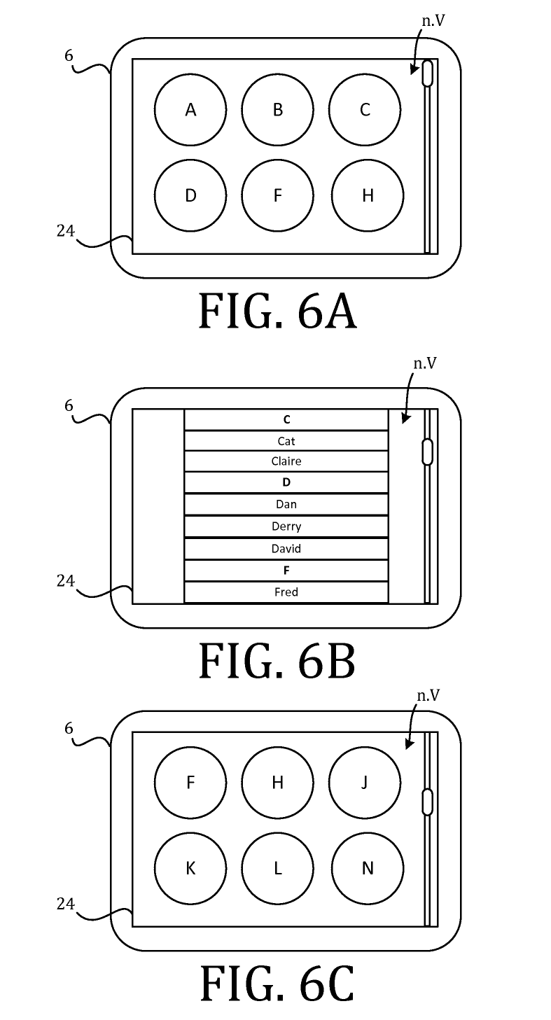

FIGS. 6A-6C illustrate another example, based on semantic zoom. In the view of FIG. 6A, only aggregate nodes defining non-empty groups are shown (in this example, no contacts begin with “E”, thus no “E” group is shown in FIG. 6A), defined by a filter “f_negrp”.

By making a pinch-out gesture on the touchscreen of the display 24, on the representation of the group “C” in FIG. 6A, the user can switch to a full lit view as shown in FIG. 6B, defined by the filter f_full.

To ensure that the list view of FIG. 6B begins with “C”, where possible a cross-index (otherwise a reverse-indexd) lookup is used to determine the index I(f_full) of the “C” node, as in the above example.

Though not shown explicitly, the user can scroll through the list view of FIG. 6B. The user can make a pitch-in gesture at a point on the list to ‘zoom out’ back to the group view defined by f_negrp. So for example, if the user were to pinch-in on the contact “Fred”, a cross-index or reverse-index lookup on Fred would determine its index I(f_negrp) filter or the to be Q″. Because “Fred” is not an aggregate node, it does not satisfy the filter f_negrp—the first node in the container to have the index i(f_negrp)=Q″ will be the aggregate node “F”. Thus, assuming a switch back to the group view by pinching in on “Fred” causes the first node in the list to have the index Q″ to be displayed, the first-displayed node in the group view will be “F” as shown in FIG. 6C.

### Group Cardinality Vectors:

The group cardinality g.C vector that is stored in association with the aggregate node representing the group g can be used to obtain the number of nodes in the group that satisfy a given filter “f” in O(1) time, simply by retrieving the component g.C(ƒ). This can be used to determine one or more display parameters for node(s) in that group.

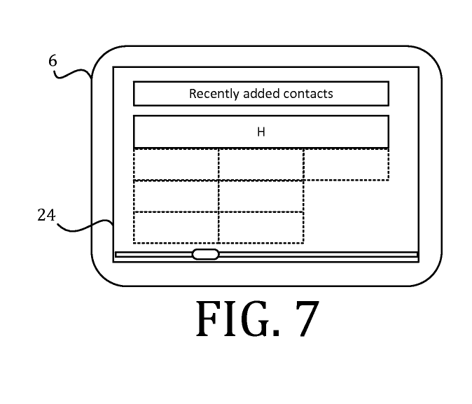

For example, FIG. 7 shows an example in which all recently added contacts, i.e. satisfying “f_recent”, in the group H are displayed in a table format. The component g.C(f_recent) of H's cardinality vector, which is seven in this example, denotes the fact that H contains seven members satisfying “f_recent”—this information can be obtained in O(1) time simply by retrieving that component using the mapping between H's group key and its cardinality vector. From this, display data for displaying e.g. one row of three contacts and two rows of two contacts (seven in total) can be generated, before the group members themselves have been located. That is, the display layout can be determined before the nodes themselves have been located, as denoted by the dotted lines in FIG. 7. The group “H” is represented as a range caption labelled “H” display element, horizontally spanning the contacts in the group.

In the examples of FIGS. 5A-6C the scrolling direction is vertical (up-down), whereby the user can scroll though the list vertically. In FIG. 7 the scrolling direction is horizontal (left-right)—in this case in which case the width of the range caption (“H”) in cells (its “colspan”) is dependent on the range size (for vertical layout, it may be sufficient to wrap before and after the header, so the range size is immaterial.)

Note: in the above, mode switches are manual. However, mode switch signal can also be generated automatically, i.e. not in response to an explicit instruction from the user, e.g. in response to detecting a certain event.

Whilst the above is described in the context of a skip-list application, the techniques can be applied to other types of data structure. For example, another type of probabilistic ordered container, a so-called “Cartesian tree” can be extended in a similar way to a similar end.

Whilst in the above the container is ordered by value, it is possible to maintain a similar hierarchical structure that is within the scope of the present disclosure without that this ordering criteria. In particular, index lookups do not require the container to be ordered by value—this applies to both cross-index searches and index-to-value searches. The resulting (unordered) structure can for example be used to store samples (e.g. sensor data, log messages, etc.) in ad-hoc (e.g. historical) order.

For example, in a Cartesian tree implementation a so-called “Implicit Cartesian tree” (see: http://codeforces.com/blog/entry/3767) can be used to manipulate array-like structures without sequential memory allocation.

Whilst in the computed distances are stored in the nodes of the data structure, this is not essential; they can be stored in any suitable manner in the data structure (e.g. in an element(s) separate from the nodes).

Moreover, whilst in the above, links are embodies by pointers stored in the nodes from which they are directed, in generate the directional edges can be embodied in any alternative ways. For example they may be defined by a separate set of edge data and embodied by pairs of node identifiers in the set of edge data, they may be inherent in the data structure, elementary links may be defined by associating elementary indices with each node (i.e. if one node has an elementary index “i” and another “i+1”, those indices inherently define an elementary link form node i to node i+1) etc.

A first aspect of the subject matter is directed to a computer comprising: an access module configured to access a data structure, wherein the data structure is formed of at least one sequence of nodes having a plurality of elementary links, each elementary link being a directional edge from a respective node in the sequence to the next adjacent node in the sequence; and a distance computation module configured to compute, based one or more predicates, a distance along each elementary link for each of the one or more predicates, and store it in the data structure in association with that elementary link, wherein the distance along that elementary link is computed for that predicate by applying that predicate to the node to which that elementary link is directed, and is zero-valued unless that node satisfies that predicate.

In embodiments, the one or more predicates may be a plural number of predicates, whereby the distance computation module may be configured to compute for each elementary link a distance vector along that link having that number of components (i.e. distance components), each component being the distance along that elementary link computed for a different one of the predicates.

The computer may be for performing an index lookup on a data structure, and the computer may further comprise: an index search input configured to receive a target index for a target predicate of the one the or more predicates; and an index search module configured to use the distance along at least one of the elementary links computed for the target predicate to locate a target node in the sequence that has an index for the target predicate that matches the target index, the index of each node in the sequence for the target predicate being a sum of the distance(s) for the target predicate along the elementary link(s) from a reference node in the sequence to that node.

The computer may comprise a cross-index lookup module configured to perform a cross-index lookup for the target node by: determining, based on said locating of the target node by the index search module, the index of the target node for a different one of the predicates.

For example, the computer may comprise a user interface controller configured to: control a display to display at least the target node, and in response to a mode switch signal, control the display to display a set of one or more of the nodes that satisfy the different predicate (assuming there are such node(s)), the set being selected by the user interface controller based on the cross-index lookup.

Should there be no nodes that satisfy the different predicate, an empty set (i.e. no nodes) may be displayed in response to the mode switch signal.

For example, the selected set may comprise the target node and/or a different node in the sequence having the same index for the different predicate (e.g. if the target node does not satisfy the different predicate).

Alternatively or in addition, the computer may be for performing a value lookup and comprise: a value search input configured to receive a target node value; a value search module configured to locate a target node in the sequence that matches the target node value by comparing node values of nodes in the sequence to the target node value.

In some cases, the computer may further comprise: a reverse-index lookup module configured perform a reverse-index lookup for the target node by: determining, based on said locating of the target node by the value search module, an index of the target node for one of the predicates using the distance along at least one of the elementary links computed for said predicate, the index of each node in the sequence for said predicate being a sum of the distance(s) for said predicate along the elementary link(s) from a reference node in the sequence to that node.

For example, the computer may comprise a user interface controller configured to: control a display to display at least the target node; and in response to a mode switch signal, controlling the display to display a set of one or more of the nodes that satisfy said predicate, the set being selected by the user interface controller based on the reverse-index lookup.

For example, the selected set may comprise the target node and/or a different node in the sequence (e.g. if the target node does not satisfy said predicate) having the same index for said predicate.

The computer may comprise a user interface configured to use the located target node output to a user of the computer a display element representing the target node.

As a first example, the search module may be configured to locate the target node by implementing the following operations: locating an earlier node in the sequence that has an index for the target predicate that is less than the target index, determining that the index of the earlier node is less than the target index, and in response to said determination, performing an explore algorithm for the earlier node by: (i) generating a sum of the earlier node's index with the distance for the target predicate along the elementary link from the earlier node to the next adjacent node in the sequence, and (ii) if the sum is less than the target index, repeating the explore algorithm for the next adjacent node in the sequence, whereby the explore algorithm is performed repeatedly until the target index value is reached, thereby locating the target node.

The sequence may have higher-level links in addition to the elementary links, each of the higher-level links being a directional edge from a respective node in the sequence to a respective later node in the sequence; there may be one or more of the elementary links between its respective node and its respective later node, wherein each of the elementary links may have a lowest link level and each of the higher-level links may have a link level above the lowest link level. The computer may comprise: a distance aggregation module configured compute a distance along each of the higher-level links for each predicate, and store it in the data structure in association with that link, the distance along that higher-level link being computed for that predicate by summing the distance(s) for that predicate along one or more lower-level links between that higher-level link's respective node and its respective later node, the one or more lower level-links having a link level immediately below the link level of that higher-level link.

For the above-mentioned first example, one of the higher-level links may be from a yet-earlier node in the sequence to the earlier node from which the target node is located, and the earlier node may be located from the yet-earlier node by summing the index of the yet-earlier node with the distance along the higher-level link from the yet-earlier node to the earlier node, thereby computing the index of the earlier node.

The computer may comprise an aggregate node generation module configured to generate one or more aggregate nodes, each of the aggregate nodes representing a respective group of the nodes in the sequence, and to insert each aggregate node at a respective position in the sequence with an elementary link to that aggregate node from the node immediately before its respective position, wherein the distance computation module is configured to compute a distance for each predicate along that elementary link that is zero-valued unless at least one node in that respective group satisfies that predicate.

The group may be contiguous (i.e. a range of adjacent nodes in the sequence).

For at least one of the one or more aggregate nodes, its respective position may be immediately before the first node in its respective group, immediately after the last node in its respective group, or in between a pair of nodes in its respective group.

In some cases, the respective group represented by one of the aggregate nodes may contain at least another of the aggregate nodes, wherein for at least one of the one or more predicates, the other aggregate node may satisfy that predicate if and only if at least one node in the other aggregate node's respective group satisfies that predicate.

The group aggregation module may be configured to store in association with each aggregate node a respective cardinality component for each of the one or more predicates, which indicates the number of nodes in its respective group that satisfy that predicate.

If there are a plural of predicates, each aggregate node has that number of associated cardinality components and these constitute a cardinality vector of that node.

For example, the computer may comprise a user interface controller configured to use the cardinality component for at least one of the aggregate nodes to generate display data for displaying, on a display, at least some of the nodes in its respective group.

As another example, the computer may comprise a user interface controller configured to use the cardinality component for at least one of the aggregate nodes to generate display data for displaying the aggregate node on a display.

The computer may comprise a display configured to use the display data to display the at least some nodes and/or the aggregate node.

The display data for the at least some nodes may define a layout of the at least some nodes on the display, those nodes being displayed according to the defined layout.

The display data for the aggregate node may define a region of the display area to be occupied by size of the displayed aggregate node, which is determined by the user interface controller based on the cardinality component, the aggregate node being displayed in the defined region of the display.

One of the one or more predicates may be satisfied only by aggregate nodes; or (alternatively) only by nodes other than the aggregate nodes.

The one or more predicates may be a plural number of predicates, wherein one of the predicates may be a universal predicate that is satisfied by every node in the sequence.

Each link may be embodied by a pointer to the node to which that link is directed, the pointer being stored in the node from which that link is directed, wherein the distance along that link computed for each predicate is stored in association with that pointer in: the node from which that link is directed, or the node to which that link is directed.

The distance computation module (and/or any one or more of the functional modules disclosure herein) may be implemented by a computer program configured to be executed by a processor of the computer.

The one or more predicates may be a plural number of predicates, wherein the distances along the elementary links for a first and a second of the predicates are computed in parallel by separate threads of the computer program. For example, the first and second predicates may be independent of one another.

The distance computation module may be configured to: compute the distances along the elementary links for a first of the one or more predicates by applying the first predicate to each of the nodes, and compute the distances along the elementary links for a second predicate using (i) the distances computed for the first predicate, (ii) a known relationship between the first predicate and the second predicate and (iii) the second predicate, whereby in calculating the distances along the elementary links for the second predicate, the second predicate is applied to only some of the nodes in the sequence by the distance computation module.

As an example, the data structure may constitute an address book, wherein each node may represent a contact of a user of the computer within a communication system.

A second aspect of the present subject matter is directed to a computer-implemented method of optimising an electronically stored data structure for an index lookup, wherein the data structure is formed of at least one sequence of nodes having a plurality of elementary links, each elementary link being a directional edge from a respective node in the sequence to the next adjacent node in the sequence, the method comprising: computing, based one or more predicates, a distance along each elementary link for each of the one or more predicates by applying that predicate to the node to which that elementary link is directed, wherein the distance is zero-valued unless that node satisfies that predicate; and storing in the data structure, in association with each elementary link, the one or more distances along that link computed for the one or more predicates.

In embodiments, the one or more predicates may be a plural number of predicates, whereby for each elementary link a distance vector along that link having that number of components may be computed, each of the components being the distance along that elementary link computed for a different one of the predicates.

Any of the computer functionality disclosed herein may be implemented in embodiments of the method.

A third aspect of the present subject matter is directed a computer program product comprising executable code stored on a computer-readable storage medium, the code configured when executed on a computer to implement any of the method steps or computer functionality disclosed herein.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs), such as any of the method steps of FIG. 3 or 4. The program code can be stored in one or more computer readable memory devices. The features of the techniques described below are platform-independent, meaning that the techniques may be implemented on a variety of commercial computing platforms having a variety of processors.

For example, the user device 6 may also include an entity (e.g. software) that causes hardware of the user device 6 to perform operations, e.g., processors functional blocks, and so on. For example, the user device 6 may include a computer-readable medium that may be configured to maintain instructions that cause the user device 6, and more particularly the operating system and associated hardware of the user device 6 to perform operations. Thus, the instructions function to configure the operating system and associated hardware to perform the operations and in this way result in transformation of the operating system and associated hardware to perform functions. The instructions may be provided by the computer-readable medium to the user device 6 through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer comprising:
an access module configured to access a data structure, wherein the data structure is formed of at least one sequence of nodes having a plurality of elementary links, each elementary link being a directional edge from a respective node in the sequence to the next adjacent node in the sequence; and
a distance computation module configured to compute, based one or more predicates, a distance along each elementary link for each of the one or more predicates, and store it in the data structure in association with that elementary link, wherein the distance along that elementary link is computed for that predicate by applying that predicate to the node to which that elementary link is directed, and is zero-valued unless that node satisfies that predicate.

2. A computer according to claim 1, wherein the one or more predicates are a plural number of predicates, whereby the distance computation module is configured to compute for each elementary link a distance vector along that link having that number of components, each component being the distance along that elementary link computed for a different one of the predicates.

3. A computer according to claim 1 for performing an index lookup on a data structure, the computer further comprising:
an index search input configured to receive a target index for a target predicate of the one the or more predicates; and
an index search module configured to use the distance along at least one of the elementary links computed for the target predicate to locate a target node in the sequence that has an index for the target predicate that matches the target index, the index of each node in the sequence for the target predicate being a sum of the distance(s) for the target predicate along the elementary link(s) from a reference node in the sequence to that node.

4. A computer according to claim 2, comprising a cross-index lookup module configured to perform a cross-index lookup for the target node by:
determining, based on said locating of the target node by the index search module, the index of the target node for a different one of the predicates.

5. A computer according to claim 4, comprising a user interface controller configured to:
control a display to display at least the target node, and
in response to a mode switch signal, control the display to display at least a set of one or more of the nodes that satisfy the different predicate, the set being selected by the user interface controller based on the cross-index lookup.

6. A computer according to claim 1 for performing a value lookup on a data structure, comprising:
a value search input configured to receive a target node value;
a value search module configured to locate a target node in the sequence that matches the target node value by comparing node values of nodes in the sequence to the target node value; and
a reverse-index lookup module configured perform a reverse-index lookup for the target node by: determining, based on said locating of the target node by the value search module, an index of the target node for one of the predicates using the distance along at least one of the elementary links computed for said predicate, the index of each node in the sequence for said predicate being a sum of the distance(s) for said predicate along the elementary link(s) from a reference node in the sequence to that node.

7. A computer according to claim 3, wherein the search module is configured to locate the target node by implementing the following operations:
locating an earlier node in the sequence that has an index for the target predicate that is less than the target index,
determining that the index of the earlier node is less than the target index, and
in response to said determination, performing an explore algorithm for the earlier node by: (i) generating a sum of the earlier node's index with the distance for the target predicate along the elementary link from the earlier node to the next adjacent node in the sequence, and (ii) if the sum is less than the target index, repeating the explore algorithm for the next adjacent node in the sequence, whereby the explore algorithm is performed repeatedly until the target node is located.

8. A computer according to claim 1, wherein the sequence has higher-level links in addition to the elementary links, each of the higher-level links being a directional edge from a respective node in the sequence to a respective later node in the sequence, there being one or more of the elementary links between its respective node and its respective later node, wherein each of the elementary links has a lowest link level and each of the higher-level links has a link level above the lowest link level, the computer comprising:
a distance aggregation module configured compute a distance along each of the higher-level links for each predicate, and store it in the data structure in association with that link, the distance along that higher-level link being computed for that predicate by summing the distance(s) for that predicate along one or more lower-level links between that higher-level link's respective node and its respective later node, the one or more lower level-links having a link level immediately below the link level of that higher-level link.

9. A computer according to claim 3, wherein one of the higher-level links is from a yet-earlier node in the sequence to the earlier node from which the target node is located, the earlier node being located from the yet-earlier node by summing the index of the yet-earlier node with the distance along the higher-level link from the yet-earlier node to the earlier node, thereby computing the index of the earlier node.

10. A computer according to claim 1, comprising:
an aggregate node generation module configured to generate one or more aggregate nodes, each of the aggregate nodes representing a respective group of the nodes in the sequence, and to insert each aggregate node at a respective position in the sequence with an elementary link to that aggregate node from the node immediately before its respective position, wherein the distance computation module is configured to compute a distance for each of the one or more predicates along that elementary link, wherein for at least one of the one or more predicates the computed distance along that elementary link is zero-valued unless at least one node in that respective group satisfies that predicate.

11. A computer according to claim 10, wherein the respective group represented by one of the aggregate nodes contains at least another of the aggregate nodes, wherein for at least one of the one or more predicates, the other aggregate node satisfies that predicate if and only if at least one node in the other aggregate node's respective group satisfies that predicate.

12. A computer according to claim 10, wherein the group aggregation module is configured to store in association with each aggregate node a respective cardinality component for each of the one or more predicates, which indicates the number of nodes in its respective group that satisfy that predicate.

13. A computer according to claim 12, comprising a user interface controller configured to use the cardinality component for at least one of the aggregate nodes to generate display data for displaying, on a display, at least some of the nodes in its respective group.

14. A computer according to claim 1, wherein the one or more predicates are a plural number of predicates, wherein one of the predicates is a universal predicate that is satisfied by every node in the sequence.

15. A computer according to claim 1, wherein each link is embodied by a pointer to the node to which that link is directed, the pointer being stored in the node from which that link is directed; and/or wherein the distance along that link computed for each predicate is stored in association with that pointer in: the node from which that link is directed, or the node to which that link is directed.

16. A computer according to claim 1, wherein the distance computation module is implemented by a computer program configured to be executed by a processor of the computer, wherein the one or more predicates are a plural number of predicates, wherein the distances along the elementary links for a first and a second of the predicates are computed in parallel by separate threads of the computer program.

17. A computer according to claim 1, wherein the distance computation module is configured to:
compute the distances along the elementary links for a first of the one or more predicates by applying the first predicate to each of the nodes, and
compute the distances along the elementary links for a second predicate using (i) the distances computed for the first predicate, (ii) a known relationship between the first predicate and the second predicate and (iii) the second predicate, whereby in calculating the distances along the elementary links for the second predicate, the second predicate is applied to only some of the nodes in the sequence by the distance computation module.

18. A computer according to claim 3, comprising a user interface configured to use the located target node output to a user of the computer a display element representing the target node.

19. A computer-implemented method of optimising an electronically stored data structure for an index lookup, wherein the data structure is formed of at least one sequence of nodes having a plurality of elementary links, each elementary link being a directional edge from a respective node in the sequence to the next adjacent node in the sequence, the method comprising:
computing, based one or more predicates, a distance along each elementary link for each of the one or more predicates by applying that predicate to the node to which that elementary link is directed, wherein the distance is zero-valued unless that node satisfies that predicate; and
storing in the data structure, in association with each elementary link, the one or more distances along that link computed for the one or more predicates.

20. A computer program product comprising executable code stored on a computer-readable storage medium, the code configured when executed on a computer to perform the following operations:
accessing a data structure, wherein the data structure is formed of at least one sequence of nodes having a plurality of elementary links, each elementary link being a directional edge from a respective node in the sequence to the next adjacent node in the sequence;
computing, based one or more predicates, a distance along each elementary link for each of the one or more predicates by applying that predicate to the node to which that elementary link is directed, wherein the distance is zero-valued unless that node satisfies that predicate; and
storing in the data structure, in association with each elementary link, the one or more distances along that link computed for the one or more predicates.
